(19) United States
(12) Patent Application Publication
(10) Pub. No.: US 2012/0321753 A1
(43) Pub. Date: Dec. 20, 2012

(54) Microwave Heated Snack

(75) Inventors: John Joseph Michels, Highland Village, TX (US); Joseph Paul Sagel, Plano, TX (US); Patrick Ryan Windley, Frisco, TX (US)

(73) Assignee: FRITO-LAY NORTH AMERICA, INC., Plano, TX (US)

(21) Appl. No.: 13/164,061

(22) Filed: Jun. 20, 2011

(51) Int. Cl. B65D 81/34; A23L 1/01

(52) U.S. Cl. 426/107; 426/243

(57) ABSTRACT

A retail package having a shelf-stable crispy food product and at least one packet of a complimentary shelf-stable topping and a method for preparing a microwave heated snack. The present invention allows a consumer to purchase together and heat a crispy food product and a complimentary topping simultaneously in a microwave oven. The package is ideal for combinations of chips and cheese or any other compatible crispy and non-crispy food products that are desirably kept in separate containers and heated shortly before consuming.

### BACKGROUND OF THE INVENTION

1. Technical Field

The present invention relates to a retail package for a microwave heated snack food and the method of heating the same.

2. Description of Related Art

The design and construction of packaging for containers of consumables, such as potato chips, tortilla chips, corn chips or other snack food products, involves consideration of application specific criteria. For example, mixing separate, complementary food products just prior to consumption is often popular with consumers. Therefore, it may be desirable to construct a container or container packaging so that two or more complementary food products can be sold and consumed together.

Furthermore, food ingredients are typically enclosed in a sealed food package and thus approach equilibrium with the relative humidity inside the package. Thus, moisture migration can make it difficult to achieve a long shelf life on multiple compartment packages if snack products are stored sharing the same headspace. Additionally, oxygen and moisture migration into a container reduces the product's shelf life.

It is also desirable to heat some food products before they are consumed. However, some food products that the consumer desires to combine react differently to various heating methods. These differing reactions to heating methods make it counterintuitive to heat different types of consumables together. The particular method used to heat the food products also affects the product packaging.

The prior art fails to disclose a container having all of the above advantages and taking into account all of the above considerations. Consequently, a need exists for a retail package containing complimentary food products having differing moisture contents that allows a consumer to easily heat and consume the snack food product within the same package. Such design should be simple and inexpensive to manufacture and be intuitively functional to the consumer.

### SUMMARY OF THE INVENTION

The present invention comprises a retail package containing a shelf-stable crispy food product and at least one packet of a complimentary shelf-stable topping for the crispy food product. The complimentary topping has a moisture content sufficient to create a steam atmosphere and protect the crispy food product from burning when the package is heated in a microwave oven. The topping is packaged in a separate packet made of a high moisture barrier film to prevent moisture migration from the topping to the crispy food product. In one embodiment, the retail package is a vertical stand-up, pillow or double-gusseted bag manufactured from a microwavable film.

To prepare the heated snack food product, the retail package is opened and the packets of toppings are removed. The topping packets are then opened and poured evenly over the crispy food product. The package is heated in a microwave for about 30 seconds and then for additional 10 second intervals until the topping is sufficiently melted.

The present invention allows consumers to purchase and heat a crispy snack food and complimentary toppings together, thus providing a “real food” experience. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a cut-away perspective view illustrating one embodiment of the retail package of the present invention;

FIG. 2 is an overhead view illustrating one embodiment of the retail package of the present invention; and

FIGS. 3a and 3b are perspective views of a vertical stand-up bag used in one embodiment of the present invention.

### DETAILED DESCRIPTION

Crispy snack food products, such as tortilla chips, potato chips, corn chips, fruit and vegetable chips, crackers and pretzels, are typically consumed at room temperature because they are sold in individual single serving or multiple serving packages from convenience stores or grocery stores to consumers long after the snacks have been cooked. However, some restaurants offer these snack food products to consumers fresh from the cooking medium, and thus still hot. Other restaurants offer the snack items warm to consumers by temporarily storing them under warming lamps or the like. The term “crispy food product” as used herein is defined as a food product comprising less than 4% moisture by weight.

These crispy snack food products are also typically consumed with a complimentary topping such as a condiment or dipping sauce (sometimes referred to as “dip”). Examples of dipping sauces include cheese sauce, salsa, chili, soups, stew and bean dip. Here again, dipping sauces are typically sold from grocery or convenience stores to consumers at room temperature long after they have been cooked or prepared. Restaurants, however, routinely offer these dipping sauces in their freshly prepared or still hot form. The term “topping” as used herein is defined as a food product with a moisture content between about 10% and about 50% by weight. The term “product” as used herein is includes a single product, a group of products, or a mixture of products.

One goal of the present invention is to provide consumers the ability to easily and efficiently replicate the restaurant experience of eating hot crispy snacks with complimentary toppings using products purchased at grocery or convenience stores. In the prior art, a consumer would have to purchase the crispy snack food and the topping separately. The consumer would also intuitively heat the crispy snack food and topping or dipping sauce separately. The present invention allows consumers to purchase both foods together, and heat them both at the same time.

The present invention is also directed towards a method of heating both food products at the same time using a microwave oven. The microwave oven is an appliance that can be found in many homes and businesses. During operation, a microwave oven floods the cooking chamber with non-ionizing microwave radiation, usually at a frequency of about 2.45 GHz. The power level of most consumer grade microwaves varies from about 900 Watts to about 1400 Watts.

Many food molecules (for example water molecules) are electric dipoles, which means they are positively charged at one end and a negatively charged at the other end. As the microwave radiation passes through the food, the dipole molecules rotate as they try to align themselves with the alternating electric field of the microwaves. This rotation and movement causes the food to heat up as the rotating molecules impact other molecules, putting them into motion. Microwave heating is highly efficient on liquid water (which a relatively polar molecule), and much less so on fats and sugars (which are less polar).

The microwave radiation is produced by a cavity magnetron, and directed into the food chamber through a waveguide. The waveguide in most small, consumer grade microwaves directs the microwave radiation into the food chamber from one side of the food chamber, usually at a location between the middle and the top of the food chamber. The microwave radiation generally reflects off the walls of the food chamber, but is absorbed by any water bearing food present in the food chamber, thereby exciting the water molecules. The radiation reflecting around inside the food chamber forms an approximately uniform heating environment, with some localized hotspots due to constructive interference between microwaves.

Most food products that contain water can be heated effectively in a microwave oven. However, because the activity and efficiency of the microwave heating largely depends on the amount of water present in the food being microwaved, foods containing different levels of water heat at different rates when separately heated in the same microwave. For example, in the context of the present invention, heating about two ounces of a crispy food product, such as tortilla chips, alone inside a microwave will badly burn the chips after about 40 seconds to about 75 seconds, depending on the power level of the microwave. By contrast, when about 7 ounces of a non-crispy condiment that is typically combined with a crispy food, such as cheese dip, is put into a microwave by itself for between 60 and 75 seconds, it generally heats to a temperature between about 150° F. and about 200° F., which is an acceptable and desirable temperature range for most dips. As can be seen, it would be counterintuitive to combine the chips, which burn during these time frames alone in the microwave, with the dip, which heats acceptably well during these time frames alone in the microwave.

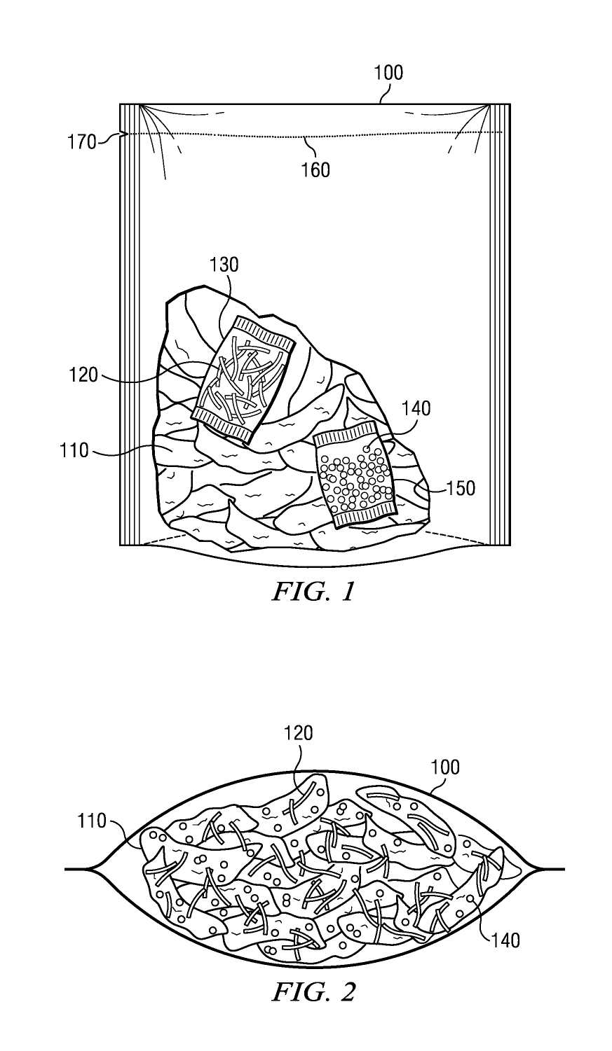

The present invention, with reference to FIG. 1, is directed to a retail package 100 having a shelf-stable crispy food product 110 and at least one shelf-stable complimentary topping 120. Upon heating the retail package 100 in a microwave oven, the consumer is provided with a restaurant style, “real food” experience. The complimentary topping 120 is shelf-stable and has a moisture content sufficient to create a steam atmosphere in the package 100 when heated in a microwave, thus protecting the lower moisture crispy food product 110 from burning during heating. The topping 120 is contained in a separate, individual packet 130 constructed of a high moisture barrier film within the retail package 100 to prevent moisture migration between the topping 120 and the crispy food product 110, thereby allowing the crispy food product 110 to retain its low moisture, crispy texture. As used herein, a high moisture barrier film is any packaging film with a moisture vapor transmission rate of 0.5 grams per meters squared (gm/m²) per day or less.

The retail package 100 may also include at least one packet 150 containing complimentary food bits 140. The complimentary food bits 140 are shelf-stable and have a moisture content of less than 10% by weight. As used herein, complimentary food bits 140 include dried food pieces, seasonings and spices. Examples of complimentary food bits 140 are bacon bits, jalapeno pieces, chives, parmesan cheese, red pepper, and pepperoni pieces. In one embodiment, the packet 150 is made of a high moisture barrier film.

The outer retail package 100 may be constructed of a microwavable film, coated paperboard or a rigid container. In one embodiment, the retail package 100 is a thermoform tray with lidding film. In one embodiment, the retail package 100 is a vertical standup, pillow or double-gusseted bag, each known in the art, manufactured of a microwavable film structure with a laser-scored precision line 160 across the top portion of the retail package 100 and notch 170 that allows a consumer to easily open the package. In one embodiment, the microwavable film is comprised of a 70 gauge layer of oriented polypropylene, an adhesive layer, and a 70 gauge layer of aluminum oxide or silicone oxide. The aluminum oxide or silicone oxide layer provides the film with the necessary moisture barrier properties. In another embodiment, the film is a structure composed of a 70 gauge oriented polypropylene layer, an adhesive layer, an aluminum oxide or silicone oxide layer, and a 110 gauge oriented polypropylene layer.

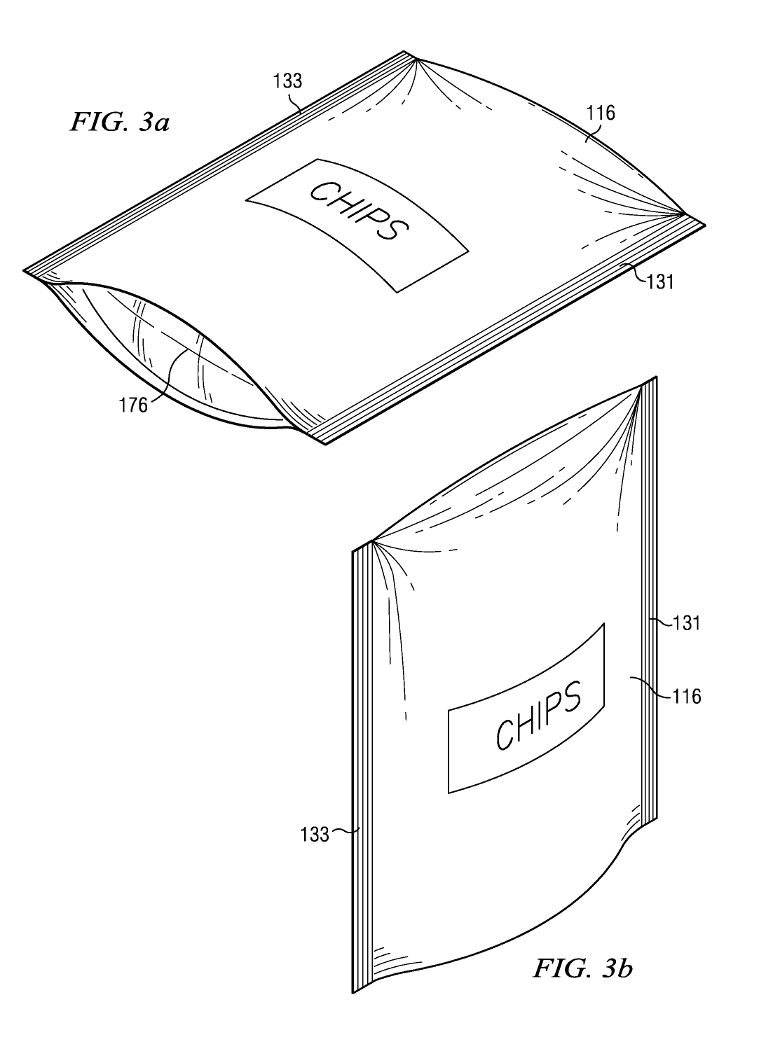

In one embodiment, a vertical stand-up bag, also known as a bowl bag, is formed using methods known in the art, such as that described in U.S. Pat. No. 6,722,106. Referring to FIGS. 3a and 3b, a sheet of packaging film 116 is formed into a tube around the forming tube of a vertical form, fill and seal machine and a vertical back seal is made with a pair of sealing jaws. A crease 176 is formed in one side of the tube of packaging film 116, which later becomes the bottom of the formed package, allowing the package to stand. A lower transverse seal 131 is formed by a pair of sealing jaws, product is introduced into the sealed tube of packaging film 116 through the forming tube, and an upper transverse seal 133 is formed, thereby completing the package. Precision laser-scoring may be used to provide an easy avenue to open the package. The result is a vertical stand-up bag that stands on one end, as shown in FIG. 3b, and provides a package from which the consumer can easily access the product and eat out of when opened.

One skilled in the art may determine the crispy food product 110 and corresponding topping 120 for each retail package 100 and the amounts of each based on the individual crispy food product 110 and complimentary topping 120 chosen. In one embodiment, the ratio of the amount of crispy food product 110 to amount of topping 120 by weight is between about 0.1-2 to 1. In one embodiment, the topping 120 contains about 10% to 50% moisture by weight and the ratio of the amount of crispy food product 110 to amount of topping 120 by weight is about 1 to 1. The about 1 to 1 ratio of crispy food product 110 to topping 120 provides sufficient topping 120 such that each piece of crispy food product 110 has some portion of topping 120 when the product is prepared. In one embodiment, the retail package 100 contains about two (2) ounces of crispy food product 110 and a packet 130 with two (2) ounces of a complimentary topping 120 that has a moisture content of about 30% by weight.

The topping 120 may be any food product that compliments the crispy food product 110, is shelf-stable, and contains a sufficient amount of water such that a steam atmosphere is created in the package 100 when the package 100 is heated in a microwave. Examples of toppings that may be used are shredded cheddar or mozzarella cheese, cheese sauce, chili, salsa, gravy, and chocolate or cream cheese icing. In the case of shredded cheddar or mozzarella cheese, the cheese is made by hurdle technology, which is well known in the art.

With reference to FIGS. 1 and 2, to create a restaurant style, “real food” experience, the consumer opens the retail package 100 at the notch 170 by tearing along the laser-scored precision line 160 and removes the packet 130 or packets of complimentary toppings 120 and packet 150 or packets of complimentary food bits 140. The individual packets 130 and 150 are then opened and the complimentary topping 120 and complimentary food bits 140 poured evenly over the crispy food product 110 in the package. The package 100 is then heated in the microwave for about thirty seconds and then for additional ten second intervals as needed to sufficiently melt or heat the toppings 120 but not burn the crispy food product 110. The package 100 is then carefully removed from the microwave for the consumer to enjoy a warm snack.

Upon heating the retail package 100 in a microwave, the high moisture topping 120 create a steam atmosphere in the package 100, thereby protecting the crispy food product 110 from burning. During the heating process, no cooking of the crispy food product 110 or toppings 120 occur, only heating as there are no microwave susceptors in the products.

### EXAMPLE 1

### Ultimate Nachos

A retail package containing two ounces of bite-size TOSTITOS ® tortilla chips, a packet of two ounces of shelf-stable shredded cheddar cheese, and a packet of shelf-stable jalapeno pieces was provided. The retail package was a vertical stand-up bag made of a film with a 70 gauge oriented polypropylene/adhesive/70 gauge aluminum oxide/110 oriented polypropylene structure. The packet of cheese, obtained from Sargento Foods Inc. (Plymouth, Wis.), was made from a 35 gauge oriented polyethylene terephthalate/adhesive/1.75 mil linear low density polyethylene-ethylene vinyl alcohol coextruded structure, which provides a shelf life of approximately six months if kept below 80° F. The jalapeno pieces were dried to contain substantially no moisture.

To prepare the heated snack food product, the retail package was opened by tearing off the top of the package along the laser-scored line. The packets of cheese and jalapeno pieces were removed and opened. The cheese and jalapeno pieces were poured evenly over the TOSTITOS ® in the package. The package was placed in a 1000W microwave and heated on high for approximately 30 seconds. The packaged was removed from the microwave with the cheese completely melted and no chips burned.

### EXAMPLE 2

### Loaded Baked Potato

A retail package containing two ounces of WAVY LAYS ® potato chips, a packet of two ounces of shelf-stable shredded cheddar cheese, and a packet of shelf-stable bacon bits was provided. The retail package was a vertical stand-up bag made of a film with a 70 gauge oriented polypropylene/adhesive/70 gauge aluminum oxide/110 oriented polypropylene structure. The packet of cheese, obtained from Sargento Foods Inc. (Plymouth, Wis.), was made from a 35 gauge oriented polyethylene terephthalate/adhesive/1.75 mil linear low density polyethylene-ethylene vinyl alcohol coextruded structure, which provides a shelf life of approximately six months if kept below 80° F. The bacon bits were dried to contain substantially no moisture.

To prepare the heated snack food product, the retail package was opened by tearing off the top of the package along the laser-scored line. The packets of cheese and bacon bits were removed and opened. The cheese and bacon bits were poured evenly over the WAVY LAYS ® in the package. The package was placed in a 1000W microwave and heated on high for approximately 30 seconds. The packaged was removed from the microwave with the cheese completely melted and no chips burned.

While the invention has been particularly shown and described with reference to a preferred embodiment, it will be understood by those skilled in the art that various changes in form and detail may be made therein without departing from the spirit and scope of the invention. All ranges herein are intended to encompass the exact ranges as well as the approximate ranges.

What is claimed is:

1. A retail package having a food product intended to be heated in a microwave oven, said package comprising:
a shelf-stable crispy food product; and
at least one packet comprising a complimentary shelf-stable topping for said crispy food product, wherein said topping comprises a moisture content sufficient to create a steam atmosphere in said retail package when said package is heated in a microwave oven.

2. The retail package of claim 1 wherein said crispy food product comprises less than about 4% moisture by weight.

3. The retail package of claim 1 wherein said toppings comprises between about 10% to about 50% moisture by weight.

4. The retail package of claim 1 wherein said package comprises a vertical stand-up, pillow or double-gusseted bag manufactured of a microwavable film.

5. The retail package of claim 1 wherein said packet comprises a high moisture barrier film.

6. The retail package of claim 1 wherein the ratio of the amount of said topping to the amount of said crispy food product by weight is about 0.1-2 to 1.

7. The retail package of claim 1 wherein the ratio of the amount of said topping to the amount of said crispy food product by weight is about 1 to 1.

8. The retail package of claim 1 wherein said package further comprises at least one packet of complimentary food bits.

9. A method for preparing a heated snack food product from a retail package having a crispy food product and at least one packet of complimentary topping for said crispy food product, said method comprising the steps of:
a) providing a package comprising a shelf-stable crispy food product and at least one packet comprising a complimentary shelf-stable topping for said crispy food product, wherein said topping comprises a moisture content sufficient to create a steam atmosphere in said retail package when said package is heated in a microwave oven;
b) opening said package;
c) removing said packets of complimentary topping;
d) opening said packets of complimentary topping;
e) pouring said toppings evenly over said crispy food product; and
f) heating said package in a microwave oven for about 30 seconds.

10. The method of claim 9 wherein step f) further comprises heating said package for about 10 second intervals after said 30 second period until said topping is sufficiently melted.

11. The method of claim 9 wherein said crispy food product comprises less than about 4% moisture by weight.

12. The method of claim 9 wherein said toppings comprises between about 10% to about 50% moisture by weight.

13. The retail package of claim 9 wherein said package comprises a vertical stand-up, pillow or double-gusseted bag manufactured of a microwavable film.

14. The retail package of claim 9 wherein said packet comprises a high moisture barrier film.

15. The retail package of claim 9 wherein the ratio of the amount of said topping to the amount of said crispy food product by weight is about 0.1-2 to 1.

16. The retail package of claim 9 wherein the ratio of the amount of said topping to the amount of said crispy food product by weight is about 1 to 1.

17. A method for preparing a heated snack food product from a retail package having a crispy food product, at least one packet of complimentary topping for said crispy food product, and at least one packet of complimentary food bits said method comprising the steps of:
a) providing a package comprising a shelf-stable crispy food product, at least one packet comprising a complimentary shelf-stable topping for said crispy food product, wherein said topping comprises a moisture content sufficient to create a steam atmosphere in said retail package when said package is heated in a microwave oven, and at least one packet of complimentary food bits;
b) opening said package;
c) removing said packets of complimentary topping and complimentary food bits;
d) opening said packets of complimentary topping and complimentary food bits;
e) pouring said toppings and food bits evenly over said crispy food product; and
f) heating said package in a microwave oven for about 30 seconds.

18. The method of claim 17 wherein step f) further comprises heating said package for about 10 second intervals after said 30 second period until said topping is sufficiently melted.

19. The method of claim 17 wherein said crispy food product comprises less than about 4% moisture by weight.

20. The method of claim 17 wherein said toppings comprises between about 10% to about 50% moisture by weight.

21. The retail package of claim 17 wherein said package comprises a vertical stand-up, pillow or double-gusseted bag manufactured of a microwavable film.

22. The retail package of claim 17 wherein said packet comprises a high moisture barrier film.

23. The retail package of claim 17 wherein the ratio of the amount of said topping to the amount of said crispy food product by weight is about 0.1-2 to 1.

24. The retail package of claim 17 wherein the ratio of the amount of said topping to the amount of said crispy food product by weight is about 1 to 1.
